(19) United States
(12) Patent Application Publication
(10) Pub. No.: US 2011/0057850 A1
(43) Pub. Date: Mar. 10, 2011

(54) PRINTED ANTENNA

(75) Inventor: LUNG-PAO CHEN, Tu-Cheng (TW)

(73) Assignee: HON HAI PRECISION INDUSTRY CO., LTD., Tu-Cheng (TW)

(21) Appl. No.: 12/632,928

(22) Filed: Dec. 8, 2009

(30) Foreign Application Priority Data
Sep. 7, 2009 (CN) 200920309711.1

(51) Int. Cl. H01Q 13/10; H01Q 1/36

(52) U.S. Cl. 343/767; 343/700 MS

(57) ABSTRACT

A printed antenna includes a feed portion and a radiating portion. The feed portion feeds electromagnetic signals, and includes a feed end and a connection end. A width of the feed portion is gradually increased from the feed end to the connection end. The radiating portion includes a first radiator and a second radiator. The first radiator is elongated, and connects to the connection end of the feed portion. One end of the second radiator is connected to the first radiator, and the other end is free. The free end is bend and bent along the feeding portion, and defines a slot between the second radiator and the first radiator and the feeding portion.

### BACKGROUND

1. Technical Field

Embodiments of the present disclosure relate to antennas, and especially to a printed antenna.

2. Description of Related Art

Inner printed antennas are traditionally designed as a monopole antenna 1, as shown in FIG. 5, and need a large area to be a ground area 3 and a clearance zone 2. Therefore, design of a printed antenna to meet good performance and miniature demands has proven a significant challenge in the industry.

### BRIEF DESCRIPTION OF THE DRAWINGS

FIG. 1 is a schematic diagram of one embodiment of a printed antenna according to the present disclosure;

FIG. 2 is a graph showing one exemplary embodiment of a return loss of the printed antenna of FIG. 1;

FIG. 3 is a horizontal radiation pattern of the printed antenna of FIG. 1;

FIG. 4 is a perpendicular radiation pattern of the printed antenna of FIG. 1; and

FIG. 5 is a schematic diagram of another embodiment of a printed antenna according to the present disclosure.

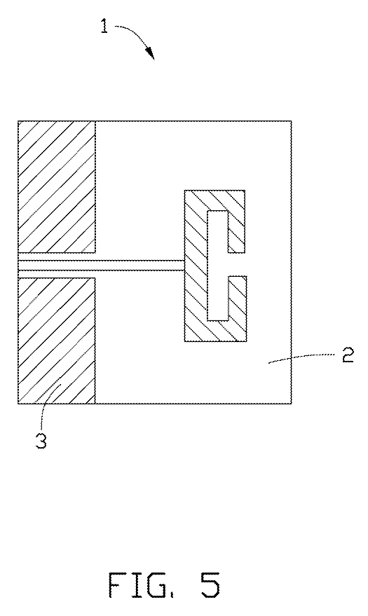

### DETAILED DESCRIPTION

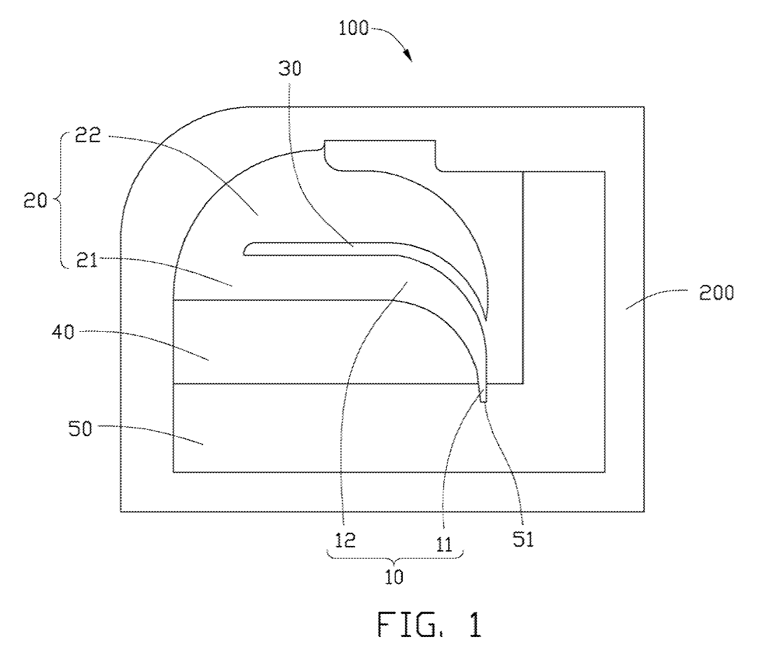

Referring to FIG. 1, a schematic diagram of one embodiment of a printed antenna 100 according to the present disclosure is shown. The printed antenna 100 comprises a feed portion 10, a radiating portion 20, a clearance zone 40, and a ground portion 50.

The ground portion 50 is “L” shape surrounding the radiating portion 20. In one embodiment, the ground portion 50 positions the printed antenna 100 to a corner of a substrate 200, to save space for a substrate 200. The ground portion 50 defines a feed via 51.

The feed portion 10 is shaped as a bent taper, to feed electromagnetic signals. In one embodiment, the feed portion 10 comprises a feed end 11 and a connection end 12. A width of the feed portion 10 is gradually increased from the feed end 11 to the connection end 12. The feed end 11 passes through the feed via 51, and the connection end 12 is connected to the radiating portion 20. In one embodiment, the connection end 12 is substantially vertical to the feed end 11 of the feed portion 10, and the feed portion 10 forms an asymmetrical structure of the feed portion 10, to match impedance. The tapered shape of the feed portion 10 can reduce return loss, and broaden the frequency bands for the printed antenna 100.

The radiating portion 20 transceives electromagnetic signals, and comprises a first radiator 21 and a second radiator 22.

The first radiator 21 is connected to the feed portion 10. In one embodiment, the first radiator 21 is elongated. A width of the first radiator 21 is the same as a width of the connection end 12 of the feed portion 10.

The second radiator 22 with one end connects to the first radiator 21, and the other end is a free end. The free end of the second radiator 22 is bent along the feeding portion 10, and defines a slot 30 between the second radiator 22 and the first radiator 21 and the feeding portion 10. In one embodiment, shapes of the second radiator can be adjusted according to residual of the substrate 200 or the clearance zone 40. The slot 30 is substantially elongated, to increase coupling between the first radiator 21 and the second radiator 22.

The clearance zone 40 is between the ground portion 50 and the radiating portion 20. In one embodiment, the printed antenna 100 is positioned on a corner of the substrate 200, to save space of the clearance zone 40, and therefore to reduce a dimension of the printed antenna 100.

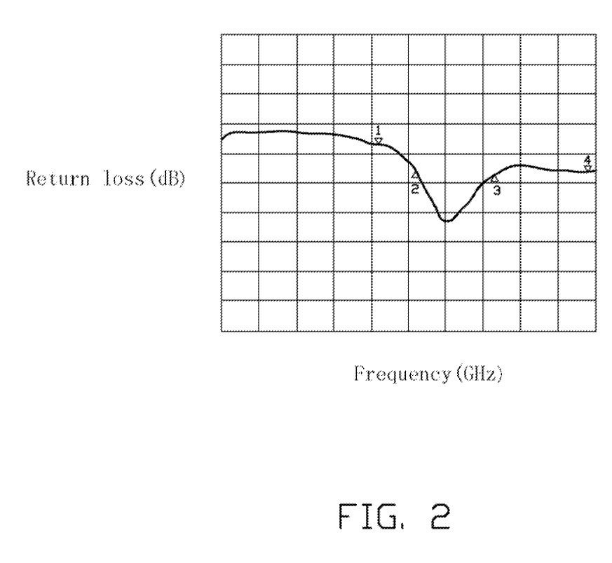

Referring to FIG. 2, an exemplary return loss of the printed antenna 1000 is shown. In test point 1, frequency band is 1.8 GHz, return loss is 13.4990 dB. In test point 2, the frequency band is 1.92 GHz, the return loss is −7.8990 dB. In test point 3, the frequency band is 2.17 GHz, the return loss is −8.8270 dB. In test point 4, the frequency band is 2.45 GHz, the return loss is −8.5900 dB. That is, the return loss is less than −7 dBm when the printed antenna 100 operates in frequency bands 1.92 GHz to 2.17 GHz, and 2.412 to 2.484 GHz, which complies with inner antenna standards, to cover WCDMA and WIFI frequency bands.

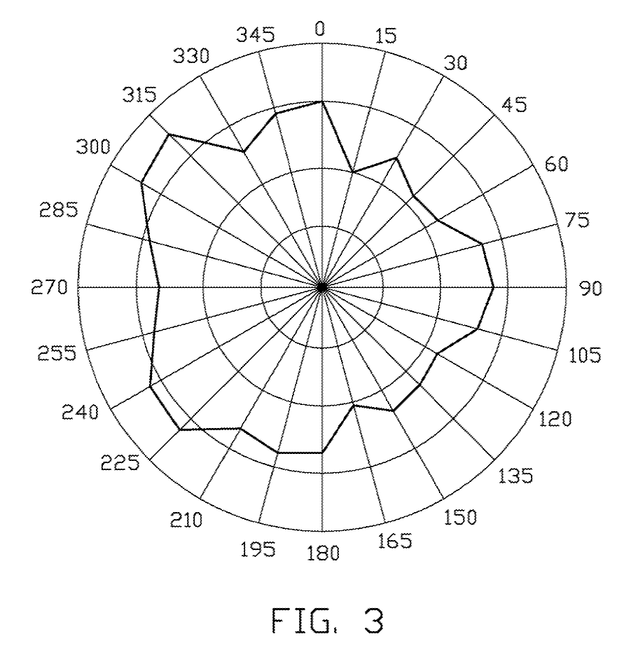

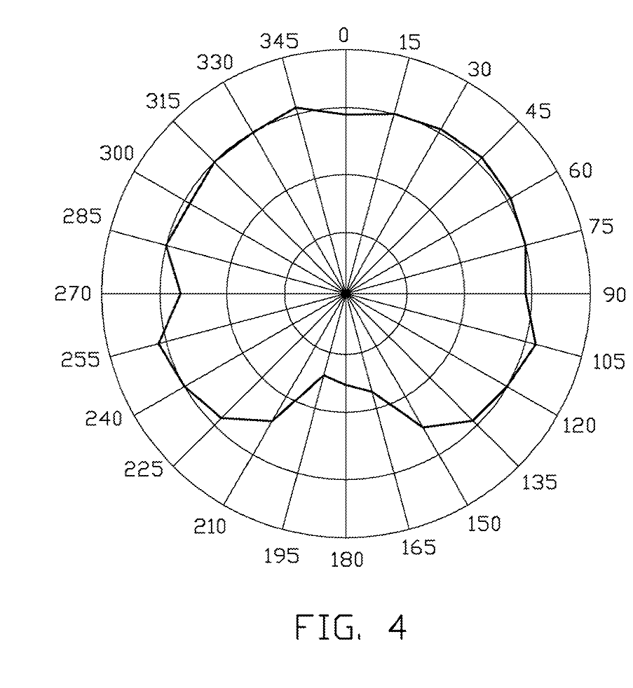

FIG. 3 and FIG. 4 are radiation patterns of the printed antenna 100. As shown, the printed antenna 100 comprises directional radiation patterns, without significant dead area.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A printed antenna, comprising:
a feed portion to feed electromagnetic signals, the feed portion comprising a feed end and a connection end, wherein a width of the feed portion is gradually increased from the feed end to the connection end; and
a radiating portion , comprising:
a first radiator, being elongated, and connected to the connection end of the feed portion; and
a second radiator, with one end connected to the first radiator, and the other end is a free end, wherein the free end is bent along the feeding portion, and defines a slot between the second radiator and the first radiator and the feeding portion.

2. The printed antenna as claimed in claim 1, wherein the feeding portion is shaped as a bent taper.

3. The printed antenna as claimed in claim 1, wherein a width of the connection end of the feeding portion is the same as a width of the first radiator.

4. The printed antenna as claimed in claim 1, wherein the connection end is substantially vertical to the feed end of the feed portion in perpendicular bisector.

5. The printed antenna as claimed in claim 1, further comprising a ground portion in “L” shape surrounding the radiating portion.

6. The printed antenna as claimed in claim 5, further comprises a clearance zone between the ground portion and the radiating portion.
